(19) United States
(12) Patent Application Publication
(10) Pub. No.: US 2002/0095460 A1
(43) Pub. Date: Jul. 18, 2002

(54) System and method for serving integrated streams of multimedia information

(76) Inventor: Michael Benson, (US)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/879,835

(22) Filed: Jun. 13, 2001

Related U.S. Application Data
(60) Provisional application No. 60/211,271, filed on Jun. 13, 2000.

(51) Int. Cl. G06F 15/16

(52) U.S. Cl. 709/204; 709/227; 709/219

(57) ABSTRACT

The present invention relates to an integrated client-server configuration for real-time teaching and conferencing sessions. There are, for example, two graphical user interface (GUI) clients—a presentation client that can originate sessions, and a participant client that can join an ongoing session or receive a replay of a recorded session. The primary role of the server is multiplexing the output of the presentation client to many participants, potentially numbering in thousands, who are able to participate in the session from other network locations, e.g., the Internet, using participant client software that functions as a plug-in to an Internet Web browser on an off-the-shelf computer with sound presentation capability. One or more presenters may control the entire session through a connection from a network location. The server is capable of storing the entire delivered contents of the session and providing for its asynchronous playback to thousands of individual participants on demand.

### CLAIM OF PRIORITY

This application claims the benefit of priority to provisional application, Serial No. 60/211,271, filed Jun. 13, 2000, the entire contents of which are hereby incorporated.

### TECHNICAL FIELD OF INVENTION

The invention relates to communicating integrated streams of information over a network, and in particular, to communicating this information over a network based on Synchronous/Asynchronous Real Time Distance Education and Conferencing (SARTDEC).

### BACKGROUND OF THE INVENTION

Existing technology is not capable of serving thousands of simultaneous users while capturing session information in such a way as to enable it to be replayed, synchronized in the same way it was originally sent, and presented by the same end user software, within transmission rates of 24 kilobits per second per user in a normal unicast Internet environment. An example of existing technology that has a disclosed method of operation is the Internet Multicast Backbone (MBone) conferencing tools, which are available from http://www-mice.cs.ucl.ac.uk/multimedia/software/ for no-cost download. These tools perform the basic conferencing roles of audio transfer, shared whiteboard, and shared text chat (video transfer also is available but is not germane to this discussion). They assume the existence of a multicasting network but with some patience also can be configured to work in the normal Internet unicast mode. They are integrated to the extent that all tools are launched from a common framework. They provide a raw capability to transfer information but no way to pre-load presentation materials. All presentation materials are transferred in real time, resulting in a high burst data rate on the network. There is no server to multiplex data to the participants, thus in the absence of a multicast network a separate instance of the software connected point-to-point from the presenter to each participant is necessary, resulting in very low scalability on a normal unicast network. While it may seem the MBone tools suffer from an unfair comparison because they were intended to operate over a multicast network, the current generation of conferencing tools suffer from the same limitations.

### SUMMARY OF THE INVENTION

The invention provides technology for serving integrated streams of Internet multimedia information for education, training and conferencing to distant participants, based on Synchronous/Asynchronous Real Time Distance Education and Conferencing (SARTDEC).

In one embodiment of the invention, there is a method of communicating information over a network. The method includes, for example, connecting a participant web browser to a server to obtain the location of configuration information and a unique session identifier for the information, loading a participant software plugin and retrieving a compound document from the location specified in the configuration information and connecting to a portal for gathering the information, wherein the portal directs the participant software plugin to an appropriate server for presentation of the information and the participant participates in the presentation or plays back a recorded presentation.

In another embodiment of the invention, there is a system for communication information over a network. The system includes, for example, a web browser connecting to a server to obtain the location of configuration information and a unique session identifier for the information, the web browser loading a participant software plugin and retrieving a compound document from the location specified in the configuration information, and system software connecting to a portal for gathering the information, wherein the portal directs the participant software plugin to an appropriate server for presentation of the information and the participant participates in the presentation or plays back a recorded presentation.

### BRIEF DESCRIPTION OF THE DRAWINGS

FIG. 1 illustrate the system of the present invention.

FIG. 2 illustrates a process for connecting to the server using a Web browser and client software.

FIG. 3 illustrates software modules in the client.

FIG. 4 illustrates a server including software modules of the present invention.

FIG. 5 illustrates possible temporal states for a user.

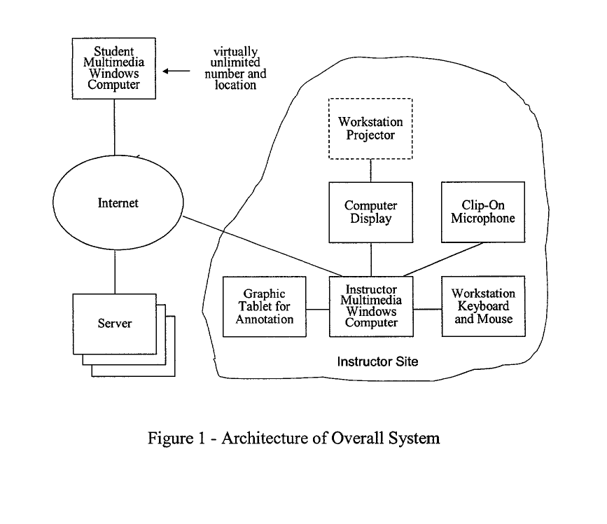

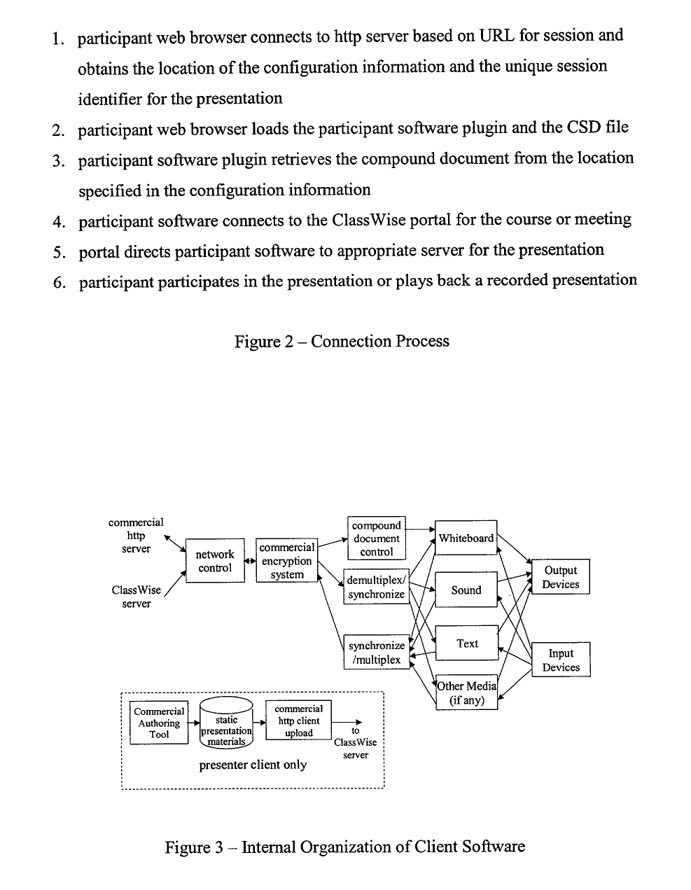

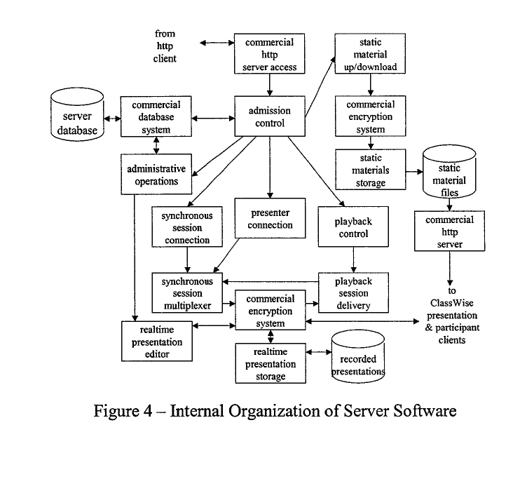

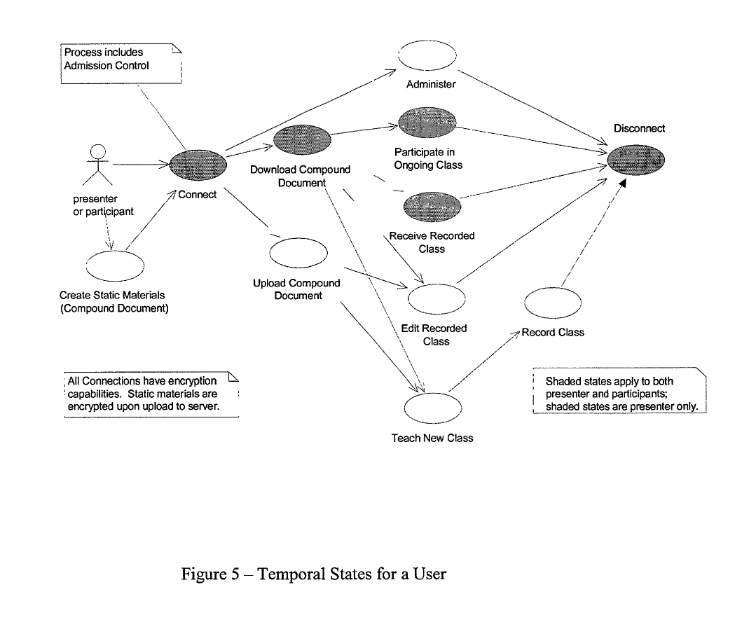

### DETAILED DESCRIPTION OF THE INVENTION

This invention is capable of creating integrated streams of network, e.g., Internet, multimedia information from SARTDEC presentations, serving these streams to large numbers of participants over the Internet while simultaneously recording the streams for later playback, and providing multimedia presentations to the participants in real time as a “virtual classroom” which represents the original presentation.

The present invention relates to an integrated client-server configuration for real-time teaching and conferencing sessions. There are, for example, two graphical user interface (GUI) clients—a presentation client that can originate sessions, and a participant client that can join an ongoing session or receive a replay of a recorded session. The primary role of the server is multiplexing the output of the presentation client to many participants, potentially numbering in thousands, who are able to participate in the session from other network locations, e.g., the Internet, using participant client software that functions as a plug-in to an Internet Web browser on an off-the-shelf computer with sound presentation capability. One or more presenters may control the entire session through a connection from a network location. The server is capable of storing the entire delivered contents of the session and providing for its asynchronous playback to thousands of individual participants on demand. All of this is achieved within a transmission capacity of 24 kilobits per second per participant, without a need for higher burst capacity to the individual participant.

Specific Capabilities of this Invention are:

a. Creating and pre-delivery of a compound document to make encryptable representations of multimedia presentations available to communication software for SARTDEC. A compound document is an object-oriented data structure used with multimedia computer systems, to integrate multiple media into a single element for transmission and storage. Our method brings together the following media:

static multimedia objects, created in advance by or for the presenter using a commercial presentation tool such as Microsoft's PowerPoint, and converted to a compressed, internal format for use by our software;

contextual information that indicates how the teaching interface and learning interface (patents applied for separately) will display and process the various dynamic, real-time and/or static elements of the SARTDEC session;

control information for correct timing and format of delivery. The packaging of the compound document is such that the entire document can be encrypted for security in transmission and storage, using commercial tools implementing encryption techniques such as Blowfish, with decryption upon reception.

b. Delivering packets in SARTDEC with appropriate synchronization based on timing derived from packets delivered to any specified media presentation component. The components share synchronization information from the selected media component (typically the presenter's voice) which is coordinated across all components and communicated across the Internet using the Real-Time Transport Protocol (RTP). The server streams RTP-encapsulated SARTDEC information as Internet packets to each participant.

c. Delivering playback of SARTDEC packets using a mechanism which derives transmission timing of each packet during its program duration in such a way that playback of large numbers of simultaneous sessions can be achieved with two threads of control. The server maintains separate state for each ongoing playback session. At any given time the information from the current packet being played back to each receiver is in active memory, and the information from the next packet for each receiver is either in memory or in the process of being fetched from mass storage. The time point of playback within the originally recorded stream of packets is under the control of each individual receiver, such that receivers can move backward and forward within the stream with resolution to the level of the packet as recorded.

d. SARTDEC process wherein educational sessions begin following real time automated downloading of presentation materials and are automatically recorded online for future playback, structured such that the identical participant software can be used to replay the presentation. The server records in a presentation file the synchronized real-time information that is delivered in user packets, using the a proprietary Streaming Format (CSF). This file is then used for playback. The static portion of the presentation, which is the compound document described in a. above, is streamed automatically to each participant on initial connection so that during the presentation the presenter can move within the static materials at will without a need to transfer those materials over the Internet at the instant of presentation. This is key to avoiding a need for burst transfer capacity greater than 24 kilobits per second, while maintaining a synchronous presentation. The real-time components can be encrypted for transmission and storage. The presentation process is performed by the presenter using the presentation software.

e. Service for SARTDEC simplifies the control interface for a presentation in an established course or meeting, as follows: To connect to a synchronous or asynchronous session, the participant clocks once on a URL. To generate a session, the presenter clocks twice: once to upload the presentation materials, and once to start the session. To make the session available for playback from an online server, the presenter clicks once at the end of a presentation session. The organization of the server software is such that the files recorded during presentation are immediately usable for playback at the discretion of the presenter, who has the option of selecting whether they are made available.

f. Record/playback service for SARTDEC such that the presenter can edit a presentation at the level of individual recorded packets after the recording is over. Individual packets can be deleted and new packets with replacement information for any of the presentation media can be inserted. The editing is performed over the Internet, using a proprietary editing software, at any time after the initial presentation has been completed.

g. SARTDEC service with admission control based on a database including a collection of properties of arbitrary complexity, defined by an administrator using the Structured Query Language (SQL). This admission information is used to control which parties can connect to synchronous sessions and which parties can playback recorded sessions asynchronously, based on the participant's identifying and authenticating information that is presented at time of connection. A log of all accesses is maintained in the database and can be retrieved by properly authenticated administrators on a basis of individual participation in synchronous and asynchronous sessions, and any other characteristic defined for the participant when the database is configured.

h. SARTDEC presentation interface that packages media content within a packet stream such that a single stream of real time transport (RTP) packets delivers the entire streamed multimedia presentation. The RTP packet bears a time stamp, part or all of the media content associated with that time, information that delineates the media type, and the packet size. By combining multimedia types on a single stream with the fundamental specifications of RTP, we enable the streaming of multiple media types in any order to be received, then reassembled in proper order and synchronized for presentation from a single connection.

i. Playback of recorded packets in SARTDEC with appropriate synchronization based on timing derived from packets delivered to any selected specified media component. Synchronized playback of all media is essential to avoid anomalies where contents of any medium is presented to the participant in a sequence other than that in which they were generated or intended to be presented. This invention solves this synchronization problem by selecting one component (typically, the audio) and referencing presentation events within all media to that component's media playback timing, based on key information within that specified medium type.

What is claimed is:

1. A method of communicating information over a network, comprising:
connecting a participant web browser to a server to obtain the location of configuration information and a unique session identifier for the information;
loading a participant software plugin and retrieving a compound document from the location specified in the configuration information; and
connecting to a portal for gathering the information, wherein the portal directs the participant software plugin to an appropriate server for presentation of the information and the participant participates in the presentation or plays back a recorded presentation.

2. The method of claim 1, wherein the information is a presentation for a course or meeting.

3. A system for communication information over a network, comprising:
a web browser connecting to a server to obtain the location of configuration information and a unique session identifier for the information, the web browser loading a participant software plugin and retrieving a compound document from the location specified in the configuration information; and
system software connecting to a portal for gathering the information, wherein the portal directs the participant software plugin to an appropriate server for presentation of the information and the participant participates in the presentation or plays back a recorded presentation.
